(19) United States
(12) Patent Application Publication
(10) Pub. No.: US 2012/0189739 A1
(43) Pub. Date: Jul. 26, 2012

(54) Naturally-Sweetened Reduced-Calorie Base Syrup Compositions and Compositions Sweetened Therewith

(75) Inventors: Thomas Rathke, Bluffton, SC (US); Darrell Gerdes, Sugarland, TX (US); James P. Hammond, Ellabell, GA (US)

(73) Assignee: IMPERIAL SUGAR COMPANY, Sugarland, TX (US)

(21) Appl. No.: 13/332,325

(22) Filed: Dec. 20, 2011

Related U.S. Application Data
(60) Provisional application No. 61/425,102, filed on Dec. 20, 2010.

(51) Int. Cl. A23L 1/09; A23F 5/00; A23F 3/00; C12G 3/00; A23L 2/58; A23C 9/156; A23L 1/302; A23L 2/60; A23L 2/00; A23L 2/02; A23C 11/10

(52) U.S. Cl. 426/67; 426/590; 426/329; 426/599; 426/594; 426/597; 426/66; 426/592; 426/598; 426/584; 426/72; 426/548

(57) ABSTRACT

A base-syrup composition is described, wherein the base syrup is made up of one or more non-nutritive sweeteners, an invert sugar, and other optional additives are included in a reduced-calorie beverage or food product to achieve a taste substantially similar to that of a full-calorie beverage or food product. The combination is suitable for use in reduced-calorie carbonated and non-carbonated beverages, wherein the products and the base fluids exhibit a Harzen color number (APHA) of ≦60. Preferably, the one or more non-nutritive sweeteners include one or more steviosides, a Stevia glycoside, a derivative of a Stevia glycoside, a glycoside of steviol, and/or a Lo Han Guo extract, including one or more mogrosides.

### CROSS REFERENCE TO RELATED APPLICATIONS

This application claims priority to U.S. Provisional Patent Application No. 61/425,102, filed Dec. 20, 2010, the contents of which are incorporated herein by reference in its entirety.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

The inventions disclosed and taught herein relate generally to beverage products comprising at least one beverage base composition and at least one natural sweetener. More specifically, the inventions disclosed herein relate to both carbonated and non-carbonated beverages and beverage-like products comprising at least one beverage base composition that includes invert syrup, and at least one natural sweetener.

### DESCRIPTION OF THE RELATED ART

Zero- or low-calorie beverages and food products are becoming increasingly popular in society. Such diet products typically contain, singularly or in blends, non-nutritive sweeteners such as aspartame, acesulfame-K, saccharin, sucralose and cyclamate. While consumers do not have to worry about calories, non-nutritive sweeteners are known to impart a taste different from that of full-calorie counterparts. So-called “diet taste” is commonly described as slow onset but lingering sweetness accompanied with a bitter and/or metallic undesirable aftertaste and a watery mouthfeel. Due to the greatly reduced sugar solid content, diet drinks also lack the body and/or thickness perception associated with full-calorie drinks. [See, for example, G. R. Shore, et al., “Taste and Mouthfeel in Low Calorie Soft Drinks”, in Contribution of Low- and Non-Volatile Materials to the Flavor of Foods, W. Pickenhagen, ed., Allured Publishing Corp., pp. 119-123 (1996)].

Zero- or low-calorie beverages and food products with tastes similar to those of full-calorie products are very desirable and have been sought after for quite some time. Currently, however, methods of improving taste have fallen short of achieving a taste similar to full-calorie products.

One option is to blend non-nutritive sweeteners. Many blends (e.g., aspartame and acesulfame-K) impart a higher degree of sweetness than individual sweeteners on an equal concentration basis. This synergistic effect results in sparing the amount of sweetener used in a given application and is therefore referred to as quantitative synergy. Blending also causes another kind of synergy, referred to as qualitative synergy, because the taste quality of the blend often is more rounded and of less bitter/metallic off-taste.

The beverage industry has taken advantage of these synergies and marketed many diet colas containing sweetener blends. For example, PepsiONE® (aspartame/acesulfame-K), Coke Light® (aspartame/acesulfame-K or sodium cyclamate/acesulfame-K/aspartame) and Diet Rite Cola® (sucralose/acesulfame-K) all contain sweetener blends. Sweetener blending can also enhance the shelf-life of diet cola, especially in cases where aspartame is used as a key sweetener. For example, most soda fountain diet colas in the United States contain aspartame, acesulfame-K, and sodium saccharin. When aspartame degrades, the other two stable sweeteners maintain a certain degree of sweet taste.

Another option is to include flavor enhancing additives. A myriad of such flavor enhancing additives have been identified to date. For example, U.S. Pat. Nos. 4,902,525 and 6,066,345, Japanese patent publication number 7-274829 and European patent publication no. EP 0 759 273 A2 relate to the addition of erythritol to beverages for the purpose of flavor enhancement. Additionally, D-tagatose has been shown to produce improved flavor and mouth-feel at low doses with combinations of intense sweeteners in a number of applications, such as in U.S. Pat. No. 7,815,956 B2.

Efforts in the beverage industry in the United States and abroad have produced is a number of taste-improved diet products. To date, however, there is no effective method of significantly improving the taste of zero- or low-calorie beverages and food products, i.e., achieving a taste similar or identical to that of full-calorie beverages and food products, while simultaneously maintaining the desired coloring of the product, as a number of reduced calorie natural sweeteners darken the color of the beverage.

In addition, further problems arise when attempting to achieve zero- or low-calorie carbonated beverages, including frozen carbonated beverages (FCBs), which are semi-frozen carbonated drinks dispensed from a FCB dispenser. Such beverages require bulk solutes to stabilize small ice crystals and to trap carbon dioxide for a good taste and a smooth texture. The most commonly employed bulk solute is sugar. However, sugar is generally highly caloric and is therefore not suitable for the formulation of zero- or low-calorie beverages, be they FCBs or other beverages. Sugar alcohols, which are known to mimic the bulk properties of ordinary sugars and have fewer calories, also are less sweet and most have undesirable gastrointestinal effects when ingested at comparable levels to sugars. Thus, making diet frozen and non-frozen carbonated beverages has been very difficult due to the need for both bulk solutes and zero or low calories.

The inventions disclosed and taught herein are directed to base syrup compositions for use in making reduced and zero-calorie beverages, both carbonated and uncarbonated, as well as reduced calorie liquid or semi-liquid comestibles, as well as methods of preparation of such a base syrup, and beverage and food compositions including such a base syrup and exhibiting reduced or zero-calories and minimal coloring of the product while simultaneously maintaining the desired flavor profile of the beverage or other comestible item.

### BRIEF SUMMARY OF THE INVENTION

Described herein are base syrups for use in the manufacture of beverages, as well as methods for the preparation of such base syrups, and beverages and comestibles which contain such base syrups.

In accordance with a first embodiment of the present disclosure, a base syrup composition for use with a reduced-calorie beverage is described, the base syrup comprising an invert sugar and at least one non-nutritive sweetener, preferably a natural non-nutritive sweetener that is plant based (extracted from, or chemically related to an extract from, a plant).

In accordance with a further embodiment of the present disclosure, a base syrup composition for use with a beverage is described, the base syrup comprising an invert sugar composition, and at least one non-nutritive sweetener. In accordance with aspects of this embodiment, the invert sugar composition is a medium invert or a full invert, as defined herein.

In accordance with a further embodiment of the present disclosure, a beverage is described, the beverage comprising about 0.1% by weight to about 98% by weight of a base syrup component, wherein the base syrup component includes an invert sugar; at least one non-nutritive natural sweetener; a pH of 2.5 to 7.5; and water, wherein the beverage exhibits a calorie content of from less than about 5 to less than about 90 calories per 8 oz serving of the beverage. In further accordance with this aspect of the disclosure, the beverage is a carbonated beverage, a non-carbonated beverage, a soft drink, a fruit juice, a fruit juice flavored drink, a fruit-flavored drink, an energy drink, a hydration drink, a sport drink, a health and wellness drink, a fountain beverage, a frozen ready-to-drink beverage, a frozen carbonated beverage, a liquid concentrate, a coffee beverage, a tea beverage, a dairy beverage, a soy beverage, a vegetable drink, a flavored water, an enhanced water, or an alcoholic beverage. In yet another aspect of this embodiment of the instant disclosure, the beverage component comprises at least one of added water, a juice, a flavorant, a sweetener, an acidulant, a colorant, a vitamin, a buffering agent, a thickener, an emulsifier, and an anti-foaming agent.

In yet another embodiment of the present disclosure, a reduced-calorie beverage is described, the beverage comprising about 0.1% by weight to about 98% by weight of a base syrup component, wherein the base syrup component includes an invert sugar and a non-nutritive natural sweetener, and wherein the base syrup has a Harzen color number (APHA) of ≦60; a pH of 2.5 to 7.5; and water, wherein the beverage exhibits a calorie content of from less than about 5 to less than about 90 calories per 8 oz serving of the beverage. In accordance with aspects of this embodiment, the beverage is a carbonated beverage, a non-carbonated beverage, a soft drink, a fruit juice, a fruit juice flavored drink, a fruit-flavored drink, an energy drink, a hydration drink, a sport drink, a health and wellness drink, a fountain beverage, a frozen ready-to-drink beverage, a frozen carbonated beverage, a liquid concentrate, a coffee beverage, a tea beverage, a dairy beverage, a soy beverage, a vegetable drink, a flavored water, an enhanced water, or an alcoholic beverage.

In a further embodiment of the present disclosure, a reduced calorie beverage is described, the beverage comprising a base syrup comprising a non-nutritive natural sweetener and sugar invert; and a flavoring, wherein the base syrup has a Harzen color number (APHA) of ≦60. In accordance with aspects of this embodiment, the beverage further comprises at least one anti-foaming agent. In further accordance with aspects of this embodiment, the non-nutritive natural sweetener is selected from one of several terpenoid glycoside, polyol extracts of Stevia rebaudiana (Bertoni), an extract of Lo Han Guo, including one or more mogrosides, and/or an extract from one or more of the Momordica species of plants.

### DEFINITIONS

The following definitions are provided in order to aid those skilled in the art in understanding the detailed description of the present invention.

As used herein, the term “food grade” means material that conforms to the standards for foods deemed safe for human consumption, as set forth in the Codex Alimentarius, produced by the Codex Alimentarius Commission (CAC) (available online at: www.codexalimentarius.net).

The term “invert” or “invert syrup”, as used herein, refers to those sucrose-based syrups (e.g., a glucose-fructose concentrated solution) resulting from the hydrolysis of sucrose into glucose, fructose, and residual sucrose, and that has a sugar content within the range of about 50° to about 70° Brix, of which at least 90% is a mixture of fructose and glucose. These syrups are produced with the glycoside hydrolase enzyme invertase or an equivalent enzyme (enzymatic conversion), or an appropriate acid (acid conversion), or heat (thermal hydrolysis) which splits each sucrose disaccharide molecule into its component glucose and fructose monomer molecules; one of each. The general reaction which produces “invert syrup” is shown below.

C₁₂H₂₂O₁₁(sucrose)+H₂O (water)=C₆H₁₂O₆(glucose)+C₆H₁₂O₆(fructose)

Such an invert syrup may be a “full invert” or a “medium invert”, in accordance with the present disclosure. The term “medium invert” as used herein refers to liquid sucrose that has been inverted using acid or enzyme treatment. The inversion is stopped before the sucrose is fully inverted to 50-50 glucose-fructose. The Brix level is typically around 76°. Medium invert is (50% sucrose, 50% invert), and has an increased sweetness of about 20% over sucrose alone. The term “full invert”, as used herein, refers to sucrose which has been fully inverted to glucose and fructose. The Brix level of full invert is typically lower than medium invert, typically in the range of about 70-72 degree brix.

The term “natural sweetener” as used herein means any of a number of naturally occurring substances, or extracts from naturally occurring substances, that provide a high sweetness per unit mass and which provide little or no nutritive value. Preferably, the natural sweetener will have a sweetness per unit mass greater than that in natural sugar. Examples of naturally occurring sweeteners suitable for use herein include, but are not limited to, extracts of the native South American plant Stevia Rebaudiana Compositae Bertoni, such as stevia, steviol, rebaudiosides A-F, and dulcosides A and B; extracts of Thladiantha grosvenorii, such as mogroside V and related glycosides and triterpene glycosides from this plant; phyllodulcin and its derivatives; thaumatin and its derivatives; mogrosides (e.g. mogroside IV, mogroside V, siamenoside, and mixtures thereof) present in extracts of the fruit of the plant family Cucurbitaceae, genus Siraitia, including S. grosvenorii, S. siamensis, S. silomaradjae, S. sikkimensis, S. Africana, S. borneesis, and S. taiwaniana; as well as other similar, naturally-occurring glycosides of the diterpene variety, as well as biologically active secondary metabolites and active compounds of plant origin having sweetening properties, such as those described by Kinghorn [Journal of Natural Products, Vol. 50 (6), pp. 1009-1024 (1987)].

As used herein, the term “non-nutritive sweetener” refers to a sweetener that does not provide a significant caloric content in typical usage amounts, i.e., one that imparts less than about 5 calories per 8 oz. serving of beverage or product to achieve the sweetness equivalent of about 10 Brix of sugar.

The term “sucrose”, or “sugar”, as used herein, means that compound having the general structure shown below, having the name α-D-glucopyranosyl-β-D-fructofuranoside (a disaccharide composed of D-glucosyl and D-fructosyl moieties), and the molecular formula C₁₂H₂₂O₁₁, as well as salts, hydrates, and stereoisomers (e.g., D,L or L, D) thereof.

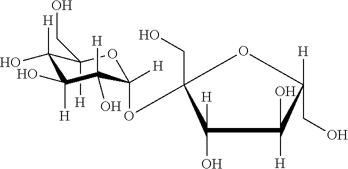

The term “brix,” or “degrees Brix,” as used herein, (and as represented by the symbol ° Bx), is meant to refer to a unit of measurement used in the food industry for measuring the approximate amount of the dissolved solids (sugar) as a sugar-to-water mass ratio of a liquid, typically expressed as a percent dissolved solids. It is typically measured with a saccharimeter that measures specific gravity of a liquid, or with a refractometer, such as the type having a crosshair reticule. For point of example, a 25° Bx solution is 25% (w/w), with 25 grams of sugar per 100 grams of solution. Or, to put it another way, there are 25 grams of sucrose sugar and 75 grams of water in the 100 grams of solution.

As used herein, the term “still beverage” means any combination of water and ingredient which is meant to be consumed in the manner of an alcohol free liquid beverage and which possesses no greater than 0.2 volumes of carbon dioxide. Non-inclusive examples of still beverages include flavored waters, tea, coffee, nectars, mineral drinks, sports beverages, vitamin waters, juice-containing beverages, punches or the concentrated forms of these beverages, as well as beverage concentrates which contain at least about 45% by weight of juice. Such beverages may be supplemented with vitamins, amino acids, protein-based, carbohydrate-based or lipid-based substances. As noted, the invention includes juice containing products, whether carbonated or still. “Juice containing beverages” or “Juice beverages”, regardless of whether still or carbonated, are products containing some or all the components of a fruit, vegetable or nuts or mixture thereof that can either be suspended or made soluble in the natural liquid fraction of the fruit.

The term “vegetable”, as used herein, includes both fruiting and non-fruiting but edible portion of plants such as tubers, leaves, rinds, and also, if not otherwise indicated, any grains, nuts, beans, and sprouts which are provided as juices or beverage flavorings. Unless dictated by local, national, or regional regulatory agencies the selective removal of certain substances (pulp, pectins, etc) does not constitute an adulteration of a juice.

The term “Sensory Evaluation”, as used herein, refers to a scientific discipline that applies principles of experimental design and statistical analysis to the use of human senses (sight, smell, taste, touch and hearing) for the purposes of evaluating consumer products. The discipline requires panels of human assessors, on whom the products are tested, and recording the responses made by them. By applying statistical techniques to the results it is possible to make inferences and insights about the products under test. It is characterized in detail in ASTM MNL14, and ICS 67.240—Sensory Analysis, both of which are incorporated herein by reference in their entirety as appropriate.

As used herein, the term “nutraceutical” refers a substance that has been shown to possess, minimally, either a general or specific health benefit or sense of wellness as documented in professional journals or texts. Nutraceuticals, however, do not necessarily act to either cure or prevent specific types of medical conditions.

As commonly understood in the art, the definitions of the terms “preserve”, “preservative”, and “preservation” do not provide a standard time period for how long the thing to be preserved is kept from spoilage, decomposition, or discoloration. The time period for “preservation” can vary greatly depending on the subject matter. Without a stated time period, it can be difficult or impossible to infer the time period required for a composition to act as a “preservative.” Therefore, as used herein, the terms “preserve”, “preservative”, and “preservation” refer to a food or beverage product protected against or a composition able to inhibit the growth of spoilage microorganisms for a period of at least 16 weeks. Typically, the product is preserved under ambient conditions, which include the full range of temperatures experienced during storage, transport, and display (e.g., 0° C. to 40° C., 10° C. to 30° C., 20° C. to 25° C.) without limitation to the length of exposure to any given temperature.

As used herein, the term “reduced calorie”, with respect to beverages or other comestibles, such as yoghurt, milk, or ice cream, means a product (i.e., a beverage) having at least a 25% reduction in calories per 8 oz. serving of beverage as compared to the full calorie version, typically a previously commercialized full-calorie version. In conjunction with this term, the phrase “low-calorie beverage” means a beverage having less than 40 calories per 8 oz. serving of beverage, while the term “zero-calorie” means a product (i.e., a beverage) having less than 5 calories per serving, e.g., per 8 oz. serving for beverages.

As used herein, all numerical ranges provided are intended to expressly include at least all of the numbers that fall within the endpoints of ranges.

### BRIEF DESCRIPTION OF THE SEVERAL VIEWS OF THE DRAWINGS

The following Figures form part of the present specification and are included to further demonstrate certain aspects of the present invention. The invention may be better understood by reference to one or more of these Figures in combination with the detailed description of specific embodiments presented herein.

FIG. 1 illustrates a plot of the color number of several blended liquid sucrose and base syrup compositions with varying concentrations of natural sweetener, in accordance with the present disclosure.

While the inventions disclosed herein are susceptible to various modifications and alternative forms, only a few specific embodiments have been shown by way of example in the drawings and are described in detail below. The Figures and detailed descriptions of these specific embodiments are not intended to limit the breadth or scope of the inventive concepts or the appended claims in any manner. Rather, the Figures and detailed written descriptions are provided to illustrate the inventive concepts to a person of ordinary skill in the art and to enable such person to make and use the inventive concepts.

### DETAILED DESCRIPTION

The FIGURE described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Applicants have created a base fluid, or syrup, composition for use with a reduced-calorie beverage product or comestible for which such a base fluid would be beneficial, as well as processes for making such base fluids, wherein the base fluid comprises invert sugar and a non-nutritive natural sweetener, as well as a number of other optional ingredients as appropriate, and wherein the product beverage or comestible prepared from the base fluid exhibits a calorie reduction up to about 99%. Further, the base fluid, or base syrup, compositions may be advantageously characterized in that they exhibit a Harzen color number (APHA) ≦60, as determined using colorimetric techniques in accordance with known analytical standards, such as ASTM D1209 and DIN EN 1559, wherein the color number ranges from 0 to about 60 or less, and more preferably from about 0 to about 59, inclusive (e.g., including about 2, about 4, about 6, about 8, about 10, about 15, about 20, about 25, about 30, about 35, about 40, about 45, about 50, about 55, and about 60, and values between these ranges, e.g., from about 2 to about 28, inclusive).

Beverage products according to the present invention include both still and carbonated beverages. As used herein, the term carbonated beverage is inclusive of any combination of water, juice, flavor and sweetener that is meant to be consumed as is an alcohol free liquid and which also is made to possess a carbon dioxide concentration of about 0.2 volumes of CO₂ or greater. The term “volume of CO₂” as used herein is understood to mean a quantity of carbon dioxide absorbed into the liquid wherein one volume CO₂ is equal to 1.96 grams of carbon dioxide (CO₂) per liter of product (0.0455M) at 25° C. Non-inclusive examples of carbonated beverages include flavored seltzer waters, juices, cola, alcoholic beverages, lemon-lime drinks, ginger ale, and root beer beverages which are carbonated in the manner of soft drinks, as well as beverages that provide health or wellness benefits from the presence of metabolically active substances, such as vitamins, amino acids, proteins, carbohydrates, lipids, or polymers thereof. Such products may also be formulated to contain milk, coffee, or tea or other botanical solids. It is also possible to formulate such beverages to contain one or more nutraceuticals.

The beverage products of the present disclosure contain at least a base syrup that is comprised of invert sugar, as well as one or more sweeteners, purified water and optionally carbonation (CO₂).

Water, the major ingredient in soft drinks as well as numerous other beverages, is the vehicle or liquid portion in which the remaining ingredients are dissolved or dispersed. Purified water is typically used in the manufacturing of soft drinks and in the beverages of the present disclosure. In order not to adversely affect beverage taste, odor or appearance, standard beverage quality water is required. The water must be clear, colorless, and low in alkalinity, free from objectionable minerals, odors, taste and organic matter and of acceptable microbiological quality based on the industry and governmental standards. Water is present in the beverage at a level ranging from about 1% (by weight) to about 99.9% (by weight) of the beverage.

According to the first embodiment of the present invention, the taste of a reduced-calorie beverage is improved by including in the beverage (a) a base syrup that comprises invert sugar, and (b) at least one non-nutritive sweetener. Beverages in accordance with the present disclosure include, without limitation, carbonated soft drinks, fountain beverages, frozen ready-to-drink beverages, coffee beverages, tea beverages, powdered soft drinks, as well as liquid concentrates, flavored waters, enhanced waters, fruit juice and fruit juice flavored drinks, sport drinks and alcoholic products. The beverage may be carbonated or noncarbonated. In accordance with selected embodiments of the present invention, the beverage is a carbonated cola-flavored soft drink or a frozen carbonated beverage (FCB).

In addition to the base syrup, the beverages of the present disclosure may comprise at least one additional ingredient selected from the group including water, a sweetener, a flavoring agent, a coloring agent, a food grade anti-foaming agent, a nutrient, calcium or a calcium derivative, an energy-generating additive, an herbal supplement, a concentrated plant extract, and a preservative, as well as other optional ingredients as will be suggested herein. Agents such as citric acid, fumaric acid, adipic acid, tartaric acid, and/or malic acid may be used as appropriate in order to provide the desired level of tartness to the beverage.

Further, in accordance with further aspects of the present disclosure, additional ingredients such as analgesics (e.g., aspirin), mild stimulants (e.g., caffeine), or relaxants, may be added in specialized product applications, in physiologically appropriate amounts.

To provide stability, the carbonated protein drink typically includes an antifoaming agent such as (without limitation) dimethylpolysiloxane, and a pH adjusting agent such as phosphoric acid, citric acid, tartaric acid, fumaric acid, adipic acid, and in some instances, lactic acid. Exemplary food grade anti-foaming agents include, but are not limited to, silica-containing defoamers (anti-foaming agents) or the reaction product of at least one compound with an active hydrogen atom and at least one alkylene oxide, wherein the defoamer has a hydroxyl equivalent molecular weight of at least about 4000 Da. Phosphoric acid is preferred as a pH adjusting agent, as the quantity required to obtain a desired pH is typically less, and the taste of the beverage is less affected by the pH adjustment. The adjusted pH of exemplary carbonated drinks typically range from about 2.0 to about 7.5, more typically from about 2.0 to about 5.5, and more typically from about 2.0 to about 3.4. To further provide stability, carbonated beverages of the present disclosure may be formulated to essentially exclude components which are not stable at the pH of the carbonated desired carbonated beverage.

Specific examples of food preservatives for use in the invention include sodium benzoate, potassium sorbate, propionic acid, sodium propionate, sodium dehydroacetate and other organic acids and their salts; butyl paraoxybenzoate, isobutyl paraoxybenzoate, propyl paraoxybenzoate and like organic acid esters; sodium sulfite, sodium hyposulfite, potassium pyrosulfite, sodium pyrosulfite, sulfur dioxide and like inorganic salts; hinokitiol, Japanese styrax benzoin extract, peptin extract and like plant extracts or plant decomposed products; and milt protein extract, E-polylysine glycine, chitosan and like proteins and their decomposed products.

As used herein, a “nutritive” sweetener refers to a sweetener which provides significant caloric content in typical usage amounts, i.e., more than about 4 calories per gram of dry weight. Such sweeteners include, without limitation, fructose, sucrose, dextrose, maltose, trehalose, rhamnose, corn syrups and fructo-oligosaccharides.

Non-nutritive sweeteners suitable for use in the present invention include, without limitation, aspartame, acesulfame salts such as acesulfame-K, saccharins (e.g., sodium and calcium salts), cyclamates (e.g., sodium and calcium salts), is sucralose, alitame, neotame, glycyrrhizin, steviosides, Lo Han Guo, neohesperidin dihydrochalcone, monatin, and protein sweeteners such as thaumatin, monellin and brazzein.

In accordance with the present disclosure, the natural product extract having a sweetness greater than that of natural sucrose is selected from the group consisting of dulcoside A, dulcoside B, stevia, stevioside, mogroside IV, mogroside V, extracts from Luo Han Guo, erythritol, xylitol, rebiana (Rebaudioside A) and other sweet components of Stevia rebaudiana (Bertoni), siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyanoside, osladin, polypodoside A, pterocaryoside A, pterocaryoside B, mukurozioside, phlomisoside I, periandrin I, abrusoside A, cyclocarioside I, and combinations thereof. In accordance with further aspects of the disclosure, the natural sweeteners can include honey, agave syrup, molasses, maple syrup, brown rice syrup, fruit juice sweeteners, high fructose corn syrup (HFCS), and the like.

The natural sweetener suitable for use with the processes of the present disclosure can be any known, natural, non-caloric or low-caloric sweetener which is safe for use in human food products, or a derivative thereof. Preferably, the natural sweetener is a glycoside (including a triterpene glycoside) or polyol, including but not limited to one of several terpenoid glycoside, polyol extracts of Stevia rebaudiana (Bertoni) which are classified as sweeteners, including but not limited to steviol, steviolbioside, stevioside, rebaudioside A (Reb A), rebaudioside B, rebaudioside C (dulcoside B), rebaudioside D, rebaudioside E, rebaudioside F, and dulcoside A, the general chemical structures of which are shown below. More preferably, the natural sweetener used in the co-crystallized products of the present disclosure is stevioside (which is about 200 times sweeter than sucrose) or rebaudioside A (which is is approximately 200-300 times sweeter than sugar, and has a sweetening power similar to that reported for aspartame, provides zero calories, and has a clean, sweet taste, as described by Prakash, et al, Food and Chemical Toxicology, Vol. 46, pp. S75-S82 (2008); and, Kinghorn, A. D., et al., in “Naturally Occurring Glycosides”, John Wiley & Sons, pp. 399-429 (1999)).

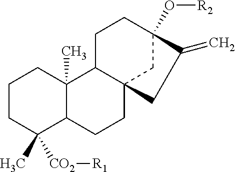

| No. | Compound Name | R₁ | R₂ |
|---|---|---|---|
| 1 | Steviol | H | H |
| 2 | steviolbioside | H | β-Glc-β-Glc (2 → 1) |
| 3 | stevioside | β-Glc | β-Glc-β-Glc (2 → 1) |
| 4 | rebaudioside A | β-Glc | 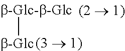 |
| 5 | rebaudioside B | H | 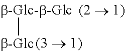 |
| 6 | rebaudioside C | β-Glc | 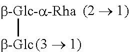 |
| 7 | rebaudioside D | β-Glc-β-Glc (2 → 1) | 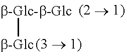 |
| 8 | rebaudioside E | β-Glc-β-Glc (2 → 1) | β-Glc-β-Glc (2 → 1) |
| 9 | rebaudioside F | β-Glc | 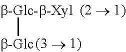 |
| 10 | dulcoside A | β-Glc | β-Glc-α-Rha(2 → 1) |
| 11 | rubusoside | β-Glc | β-Glc |

The amounts of natural sweetener and invert (full or medium) used in the production of the reduced calorie base syrup product produced by the methods described herein will vary depending upon the target product, and the calorie reduction target of that product. In example, the product can have a 33% caloric reduction, a 35% caloric reduction, a 42.5% caloric reduction, a 50% caloric reduction, and a 75% caloric reduction, and caloric reductions within the range of from about 30% caloric reduction to about 80% caloric reduction, inclusive and without limitation, e.g., a caloric reduction of about 45% or 62%.

Specific steviosides suitable for use herein include, but are not limited to, stevioside, rebaudioside A (RebA), rebaudioside C, dulcoside A, rubusoside, steviolbioside, and rebaudioside B. Steviosides are sometimes known as glycosides of steviol or stevia glycosides. Commercially, stevia glycosides are most often found in Stevia extract, which is obtained from the Stevia plant: Stevia rebaudiana (Bertoni) Bertoni of Compositae”. Rubusoside can also be obtained from Rubus suavissimus S. Lee of Rosaceae. A typical stevia extract may contain about 50% to about 55% stevioside, about 20% to about 25% rebaudioside A, about 5% to about 10% rebaudioside C, and about 3 to about 5% dulcoside A. Stevia extract from stevia plants which produce more Rebaudioside A contain about 5% to about 14% stevioside, about 65% to about 72% rebaudioside A, about 3% to about 9% rebaudioside C, and about 0.6 to about 1.2% dulcoside A. Steviosides have a steviol backbone with glucose or rhamnose moieties typically. In certain embodiments of the present disclosure, the steviosides comprises a Stevia extract. In another embodiment, Stevia extract is about 5% to about 80% Stevioside, or greater than 80% Stevioside. In certain embodiments, the Stevia extract is about 20% to about 80% Rebaudioside A, 98% Rebaudioside A, or greater than 90% Rebaudioside A. In other embodiments, the Stevia extract comprises 1) 50-55% Stevioside, 20-25% Rebaudioside A, 5-10% Rebaudioside C, and 3-5% Dulcoside A; or 2) 5-14% Stevioside, 65-72% Rebaudioside A, 3-9% Rebaudioside C, and 0.6-1.2% Dulcoside A. Stevia extract can be purified to afford an array of sweeteners varied in the purity of Rebaudioside A or Stevioside, and the present invention specifically contemplates the use of all such sweeteners comprising all percentages, from 0 to 100% (inclusive) of Rebaudioside A and Stevioside, and mixtures thereof.

Additionally, in accordance with the present disclosure, one or more of three different polymorphs of rebaudioside A may be used in the base syrup compositions of the present disclosure. The three polymorphs include: Form 1: a rebaudioside A hydrate; Form 2: an anhydrous rebaudioside A; and Form 3: a rebaudioside A solvate. In addition to the at least three polymorph forms of rebaudioside A, the purification of rebaudioside A may result in the formation of an amorphous form of rebaudioside A, Form 4. The aqueous organic solution and temperature of the purification process influence the resulting polymorph and amorphous forms in the substantially pure rebaudioside A composition. Any one or more of the three rebaudioside A polymorph and amorphous forms may be used in the compositions of the present disclosure.

Steviosides suitable for use as natural sweeteners in accordance with the present disclosure include those which have been extracted from nature and which have been modified. One such example of modified extract is Enzyme Modified Stevia Extract (also called Sugar-Transferred Stevia Extract), whose glycosides have additional glucose units through actions by enzymes such as cyclomaltodextrin glucanotransferase (CGTase). Stevia glycosides may also be synthesized (naturally, or using enzymatic or other bio-synthesis methods), and used in the compositions and beverages of the present disclosure. The amount of stevioside to be used depends upon the sweetness of the specific steviosides used and the amount of other sweeteners used. Typically, the amount ranges from about 0.01 wt. % to about 10 wt. %, preferably 0.05% to 5 wt. %, and more preferably 0.05 wt. % to 0.1 wt. %, all by weight of the finished beverage.

Lo Han Guo (LHG) is known in the art as a natural sweetening agent extracted from the Lo Han Guo plant (Siraitia grosvenori of Cucurbitaceae). LHG contains triterpene glycosides or mogrosides, preferably mogroside V, mogroside IV, siamenoside, and mixtures thereof, which constituents may be used as natural sweeteners. In particular, Lo Han Guo, the sweetening agent, contains the following glycosides: Mogroside IV, Mogroside V, Siamenoside 1, 11-Oxo-mogroside V. Any one or a combination of the above glycosides from the Lo Han Guo plant may be used as a non-nutritive sweetener in accordance with the present disclosure. In one embodiment, an extract from Lo Han Guo is used. Since Mogroside V is the sweetest component in Lo Han Guo, and it can be assayed via common HPLC method, the purity of Mogroside V is viewed as a key marker for the sweetness potency of a given Lo Han Guo extract. Commercially available Lo Han Guo extracts can contain from about 2% to ≧30% Mogroside V. From the ≧30% Mogroside V extract material, 95% Mogroside V can be obtained. The amount of Lo Han Guo sweetening agent used in the syrup or beverage compositions in accordance with the present disclosure depends on the Mogroside V content in the agent employed, as well as the amount of other sweetener used. Typically, to replace one third of the sweetener(s) in a regular beverage, the amount of Lo Han Guo extract containing about 2% Mogroside V will be from about 0.2% to about 0.6% wt. %, preferably from 0.2% to 0.5% wt. %. If the Lo Han Guo extract used contains ≧30% Mogroside V, the amount used can be from about 0.01% to about 0.06%, preferably from about 0.03% to about 0.05%, inclusive. To replace all sweetener(s) in a regular beverage, thus, becoming a diet beverage, the amount of the Lo Han Guo extract containing ≧30% Mogroside V used is from 0.1% to 0.3%; preferably from 0.15% to 0.25%. In certain embodiments, a Lo Han Guo extract is mixed with the steviosides described above, for example, a blend of an extract containing ≧30% Mogroside V and Rebaudioside A. In accordance with other aspects of the disclosure, the non-nutritive natural sweetener is a Lo Han Guo extract, such as a powder, having a mogroside IV and/or mogroside V content ranging from about 2% to about 99%, inclusive.

In accordance with the present disclosure, the non-nutritive natural sweetener may include an extract from the Momordica species of plants, which have been shown to include mogroside sweeteners, such as Mogroside V. In accordance with one aspect of the disclosure, the natural sweetener may be an extract from Momordica charantia L., (bitter gourd). Momordica charantia is a perennial herb of the family Cucurbitaceae, widely grown in Asia. The herb is endemic to tropical countries like India, S. Africa, Philippines, China and Burma.

An exemplary listing of plant species belonging to the Momordica genus, any and all of which may provide extracts for use as natural sweeteners in accordance with the present disclosure, include but are not limited to Momordica aculeata (Poir.), Momordica acuminata (Merr.), Momordica affinis (De Wild.), Momordica amaniana (Cogn.), Momordica angolensis (R. Fernandes), Momordica angustisepala (Harms), Momordica anigosantha (Hook. f.), Momordica auriculata (Noronha), Momordica balsamina (L.), Momordica bequaertii (De Wild.), Momordica boivinii (Baill.), Momordica bracteata (Hutch & Dalziel), Momordica bricchettii (Chiov.), Momordica cabrae ((Cogn.) C. Jeffrey), Momordica calantha (Gilg), Momordica camerounensis (Keraudren), Momordica chinensis (Hort.), Momordica clematidea (Sond.), Momordica charantia (L.-Bitter melon), Momordica cissoides (Planch. ex Benth.), Momordica clarkeana (King), Momordica cochinchinensis ((Lour.) Spreng.-Gac), Momordica cogniauxiana (De Wild.), Momordica cordata (Cogn.), Momordica coriacea (Cogn.), Momordica corymbifera (Hook. f.), Momordica cymbalaria (Hook. f.), Momordica denticulata (Miq.), Momordica denudata (C. B. Clarke), Momordica dictyosperma (Griseb), Momordica dioica Roxb. (ex Willd.), Momordica diplotrimera (Harms), Momordica dissecta (Baker), Momordica eberhardtii (Gagnep.), Momordica enneaphylla (Cogn.), Momordica fasciculata (Cogn.), Momordica foetida (Schumach.), Momordica gabonii (Cogn.), Momordica glabra (Zimmerman), Momordica gracilis (De Wild. & T. Durand), Momordica grandibracteata (Gilg), Momordica henriquesii (Cogn.), Momordica involucrata (E. Mey.), Momordica jeffreyana (Keraudren), Momordica laotica (Gagnep.), Momordica laurentii (De Wild.), Momordica leiocarpa (Gilg), Momordica littorea (Thulin), Momordica macrantha (Gilg), Momordica macrophylla (Gage), Momordica mannii (Hook. f.), Momordica marlothi (Harms), Momordica martinicensis (Hook. ex Wien.), Momordica meloniflora (Hand.-Mazz.), Momordica microphylla (Chiov.), Momordica mossambica (H. Schaef.), Momordica multicrenulata (Cogn.), Momordica multiflora (Hook. f.), Momordica obtusisepala (Keraudren), Momordica parvifolia (Cogn.), Momordica pauciflora (Cogn. ex Harms), Momordica pedisecta (Ser.), Momordica peteri (A. Zimm.), Momordica pterocarpa (Hochst.), Momordica pycnantha (Harms), Momordica racemiflora (Cogn.), Momordica repens (Bremek.), Momordica rostrata (A. Zimm.), Momordica rumphii (W. J. De Wilde), Momordica runssorica (Gilg), Momordica rutshuruensis (De Wild.), Momordica sahyadrica (Kattuk. & V. T. Antony), Momordica schinzii (Cogn. ex Schinz), Momordica schliebenii (Harms), Momordica sessilifolia (Cogn.), Momordica silvatica (Jongkind), Momordica somalensis (Chiov.), Momordica suringarii (Cogn.), Momordica thollonii (Cogn.), Momordica tonkinensis (Gagnep.), Momordica trifoliolata (Hook. f.), Momordica welwitschii (Hook. f.), and Momordica wildemaniana (Cogn.), as well as mixtures of extracts from any two or more Momordica species.

Another suitable non-nutritive sweetener is Miraculin. Miraculin is extracted from the “Miracle fruit” (from Richardella dulcifica). Miraculin is a protein, which is not sweet per se, but upon contacting with an acid, it imparts a strong and lingering sweetness. Other suitable non-nutritive sweeteners include sweet proteins such as Brazzein (isolated from Pentadiplandra brazzeana Baillon), Thaumatin (isolated from Thaumatococeus daniellii (Bennet) Benth), Monellin (isolated from Dioscoreophyllum cumminsii (Stapf) Diels), and Mabinlins (isolated from Capparis masakai Levl).

Preferred two-way blends include aspartame/acesulfame-K, sodium saccharin/sodium cyclamate, sucralose/acesulfame-K, Steviosides/Lo Han Guo extract, Stevia extract/Lo Han Guo extract, and Rebaudioside A/Lo Han Guo extract. Preferred three-way blends include aspartame/acesulfame-K/sodium saccharin, aspartame/acesulfame-K/sucralose, aspartame/acesulfame-K/sodium cyclamate, aspartame/sodium saccharin/sucralose, sucralose/sodium saccharin/sodium cyclamate and acesulfame-K/sodium cyclamate/sucralose. Preferred four-way blends include aspartame/acesulfame-K/sodium saccharin/sodium cyclamate, acesulfame-K/sodium saccharin/sodium cyclamate/sucralose, aspartame/acesulfame-K/sodium cyclamate/sucralose and aspartame/acesulfame-K/sodium saccharin/sucralose. Preferred five-way blends include aspartame/acesulfame-K/sodium saccharin/sodium cyclamate/sucralose.

One of ordinary skill in this art will readily appreciate that non-nutritive sweeteners may be combined in various ratios to form a non-nutritive sweetener blend suitable for use in the present invention, particularly in the base syrup composition. Precise ratios of non-nutritive sweeteners depend on the combination of sweeteners used in a given blend and the desired overall sweetness for a given application. Appropriate ratios can be readily determined by one of ordinary skill in this art.

Any nutritive sweetener is suitable for use; as used herein, a “nutritive” sweetener is one which provides significant caloric content in typical usage amounts, i.e., more than about 1 calorie per serving (8 oz. for beverages). Suitable nutritive sweeteners include, but are not limited to, fructose, sucrose, dextrose, maltose, trehalose, rhamnose, corn syrups and fructo-oligosaccharides. One of ordinary skill in this art will readily appreciate that nutritive sweeteners may be combined in various ratios to form a nutritive sweetener blend suitable for use in the present invention. Precise ratios of nutritive sweeteners depend on the combination of sweeteners used in a given blend and the desired overall sweetness for a given application. Appropriate ratios can be readily determined by one of ordinary skill in this art. Furthermore, blends of nutritive and non-nutritive sweeteners are suitable for use in the present invention, preferably in combination with stevia extract and/or Lo Han Guo extract, e.g., steviosides, enzyme modified steviosides, stevioside, rebaudioside A, rebaudioside C, dulcoside A, rubusoside, steviolbioside, rebaudioside B, Mogroside IV, Mogroside V, Siamenoside 1, 11-Oxo-mogroside V.

In addition to the non-nutritive sweetener or sweetener blend in the base syrup, a sugar alcohol may optionally be included in a reduced-calorie beverage, or in the base syrup as appropriate, in order to improve the overall taste. Sugar alcohols can act to block the lingering sweetness and the bitter/metallic aftertaste associated with the use of non-nutritive sweeteners. Sugar alcohols suitable for use in the present invention include, but are not limited to, sorbitol, mannitol, lactitol, maltitol, xylitol, erythritol and combinations thereof. Typically, the sugar alcohol (when included) is included in an amount ranging from about 0.1% to 7.5% of the finished beverage by weight. Erythritol, i.e., meso-erythritol, is especially preferred for use in the present invention. Typically, erythritol can be included in an amount ranging from about 0.1% to 3.5% of the finished beverage by weight, preferably from about 0.2% to 2.5% of the finished beverage by weight. In some applications, more than 2% or preferably about 2.5% to about 3.5% erythritol is used, all by weight of the finished beverage. In certain embodiments, 1.5% to 2.5%, 1.75% to 2.15%, 1.75%, 2.13% or 2.14% erythritol is used.

Carbon dioxide may also optionally be added to compositions and beverages of the present disclosure, in order to provide effervescence to the beverage of the instant disclosure, thereby rendering the beverage to be classified as a “carbonated beverage.” Any type of carbonation equipment can be used to effect such carbonation. Carbon dioxide enhances the beverage taste and appearance and aids in the safeguarding of the beverage purity and improve the acid resistancy of teeth by inhibiting and destroying bacteria by reducing the oxygen in the product, container it is stored in, and on and around the teeth. Since there is a definite relationship between taste and carbonation, it is important to maintain the carbonation within the desired range. The beverage of the present invention has a carbon dioxide level from about 0.5 to 17 volumes of carbon dioxide. One volume of carbon dioxide is defined as the amount of carbon dioxide absorbed by any given quantity of water at 60° F. temperature and atmospheric pressure. A volume of gas occupies the same space, as does the water by which it is absorbed.

Acid is used in carbonated and some non-carbonated beverages to add tartness and act as a mild preservative. Acids that can be used in accordance with the present invention are phosphoric, citric, malic, tartaric, lactic, formic, ascorbic, hydrochloric, sulfuric, fumaric and adipic. Carbonation itself adds acid to the beverage. The acid used in solution form can be in the amount of 0% to 0.5% by weight of the total composition. Benzoic acid, sodium benzoate or other suitable compounds can be added as a preservative. Caffeine can be eliminated from this product, as appropriate. Flavors can vary depending on what end flavor profile is desired. Minor ingredients can be reasonably altered or eliminated without departing from the scope of this invention.

In general, the beverage preservative system or beverage product of invention should have a total concentration of chromium, aluminum, nickel, zinc, copper, manganese, cobalt, calcium, magnesium, and iron cations in the range of about 1.0 mM or less, e.g., about 0.5 mM to 0.75 mM, about 0.54 mM or less. The present invention may optionally include added water that has been treated to remove metal cations, such as by the processes of reverse osmosis and or electro-deionization. Treatment by chemical means, as taught in U.S. Pat. No. 6,268,003 is acceptable, but is not preferred. The use of chemical means to reduce water hardness often results in an increase in the concentration of specific mono-valent cations, e.g., potassium cations, that serve to compromise the invention described herein. In certain exemplary embodiments, the added water has been treated by reverse osmosis, electro-deionization or both to decrease the total concentration of metal cations of chromium, aluminum, nickel, zinc, copper, manganese, cobalt, calcium, magnesium, and iron to about 1.0 mM or less.

By way of non-limiting example, juice products and juice drinks can be obtained from the fruit of apple, cranberry, pear, peach, plum, apricot, nectarine, grape, cherry, currant, raspberry, goose-berry, blackberry, blueberry, strawberry, lemon, orange, grapefruit, passion fruit, açaí, mandarin, mirabelle, tomato, lettuce, celery, spinach, cabbage, watercress, dandelion, rhubarb, carrot, beet, cucumber, pineapple, custard-apple, coconut, pomegranate, guava, kiwi, mango, papaya, watermelon, lo han guo, cantaloupe, pineapple, banana or banana puree, lime, tangerine, and mixtures thereof. Preferred juices are the citrus juices, and most preferred are the non-citrus juices, apple, pear, cranberry, strawberry, grape, papaya, mango and cherry.

Not all ranges of juice concentration can be employed. The invention could be used to preserve a formulation that is essentially 100% juice if then the presence of specific metal cation species is not exceeded. Another possibility would be to treat the juice in such a manner as to lower the concentration of specific metal cation species. Similar issues arise for juice beverages, which typically contain at least 95% juice. Formulations containing juice concentrations as high as 10% may be preserved by this invention and certainly a beverage containing less than 10% juice or less than 5% would be very likely preserved by this invention. If a beverage concentrate is desired, the fruit juice is concentrated by conventional means from about 20° Brix to about 80° Brix. Beverage concentrates are usually 40° Brix or higher (about 40% to about 75% sugar solids).

Typically, beverages will possess a specified range of acidity. Acidity of a beverage is largely determined by the type of acidulant, its concentration, and the propensity of protons associated with the acid to dissociate away from the acid when the acid is entered into solution. Any solution with a measurable pH between 0-14 possesses some measure of acidity. However, those solutions with pH below 7 are generally understood to be acidic and those above pH 7 are understood to be basic. The acidulant can be organic or inorganic. Non-exclusive examples of organic acids suitable for use herein are citric, malic, ascorbic, tartaric, lactic, gluconic, and succinic acids. Non-exclusive examples of inorganic acids suitable for use herein are the phosphoric acid compounds and the mono- and di-potassium salts of these acids. (Mono- and di-potassium salts of phosphoric acid possess at least one proton that can contribute to acidity).

The various acids can be combined with salts of the same or different acids in order to manage pH or the buffer capacity of the beverage to a specified pH or range of pH. The invention can function at a pH as low as 2.6, but the invention will function best as the pH is increased from about 2.6 up to about pH 3.8. The invention is not limited by the type of acidulant employed in acidifying the product as long as the final pH of the product does not exceed pH 7.5. Virtually any organic acid salt can be used so long as it is edible and does not provide an off-flavor. The choice of salt or salt mixture will be determined by the solubility and the taste. Citrate, malate and ascorbate yield ingestible complexes whose flavors are judged to be quite acceptable, particularly in fruit juice beverages. Tartaric acid is acceptable, particularly in grape juice beverages, as is lactic acid. Longer-chain fatty acids may be used but can affect flavor and water solubility. For essentially all purposes, the malate, gluconate, citrate and ascorbate moieties suffice.

Certain exemplary embodiments of the beverage product of invention include sports (electrolyte balancing) beverages (carbonated or non-carbonated). Typical sport beverages contain water, sucrose syrup, glucose-fructose syrup, and natural or artificial flavors. These beverages can also contain sodium chloride, citric acid, sodium citrate, mono-potassium phosphate, as well as other natural or artificial substances which serve to replenish the balance of electrolytes lost during perspiration.

### In certain exemplary embodiments, the present invention also includes beverage formulations supplemented with fat soluble vitamins. Non-exclusive examples of vitamins include fat-soluble vitamin E or its esters, vitamin A or its esters, vitamin K, and vitamin D₃, especially vitamin E and vitamin E acetate. The form of the supplement can be powder, gel or liquid or a combination thereof. Fat-soluble vitamins may be added in a restorative amount, i.e. enough to replace vitamin naturally present in a beverage such as juice or milk, which may have been lost or inactivated during processing. Fat-soluble vitamins may also be added in a nutritionally supplemental amount, i.e. an amount of vitamin considered advisable for a child or adult to consume based on RDAs and other such standards, preferably from about one to three times the RDA (Recommended Daily Amount). Other vitamins which can be added to the beverages include vitamin B niacin, pantothenic acid, folic acid, vitamin D, vitamin E, vitamin B₃ and thiamine. These vitamins can be added at levels from 10% to 300% RDA.

The compositions (base syrup, beverage, and comesitible) of the present disclosure may be enhanced by the presence of certain types of optional supplements but it is not an absolute and it will vary from beverage formulation to beverage formulation. It will be understood, however, that the inclusion of such supplements may affect the desirable color properties of the product, or otherwise effect taste and physical properties of the products. The degree to which the invention is compromised will depend on the nature of the supplement and the resulting concentration of specific metal cations in the beverage as a consequence of the presence of the supplement. For example, calcium supplements can compromise the invention, but not to the same degree as chromium supplements. Calcium supplements may be added to the degree that a critical value total calcium concentration is not exceeded (e.g., ⅓ to ½ the molar concentration of diphosphonic acid in the beverage). Calcium sources that are compatible with the invention include calcium organic acid complexes. Among the preferred calcium sources is “calcium citrate-malate”. Other calcium sources compatible with the invention include calcium acetate, calcium tartrate, calcium lactate, calcium malate, calcium citrate, calcium phosphate, calcium orotate, and mixtures thereof. Calcium chloride and calcium sulfate can also be included; however at higher levels they taste astringent and thus are less desirable for use in the compositions described herein.

Flavor Component: Beverage products according to the present invention can contain flavors of any type. The flavor component of the present invention contains flavors selected from artificial, natural flavors, botanical flavors fruit flavors and mixtures thereof. The term “botanical flavor” refers to flavors derived from parts of a plant other than the fruit; i.e. derived from bean, nuts, bark, roots and leaves. Also included within the term “botanical flavor” are synthetically prepared flavors made to simulate botanical flavors derived from natural sources. Examples of such flavors include cocoa, chocolate, vanilla, coffee, kola, tea, and the like. Botanical flavors can be derived from natural sources such as essential oils and extracts, or can be synthetically prepared. The term “fruit flavors” refers to those flavors derived from the edible reproductive part of a seed plant, especially one having a sweet pulp associated with the seed. Also included within the term “fruit flavor” are synthetically prepared flavors made to simulate fruit flavors derived from natural sources.

Artificial flavors can also be employed. Non-exclusive examples of artificial flavors include chocolate, strawberry, vanilla, cola, ginger, or artificial flavors that mimic a natural flavor can be used to formulate a still or carbonated beverage flavored to taste like fruit. The particular amount of the flavor component effective for imparting flavor characteristics to the beverage mixes of the present invention (“flavor enhancing”) can depend upon the flavor(s) selected, the flavor impression desired, and the form of the flavor component. The flavor component can comprise at least 0.005% by weight of the beverage com position.

On a case by case basis, the beverage compositions according to the present disclosure are compatible with beverages formulated to contain aqueous essence. As used herein, the term “aqueous essence” refers to the water soluble aroma and flavor materials which are derived from fruit juices. Aqueous essences can be fractionated, concentrated or folded essences, or enriched with added components. As used herein, the term “essence oil” refers to the oil or water insoluble fraction of the aroma and flavor volatiles obtained from juices. Orange essence oil is the oily fraction which separates from the aqueous essence obtained by evaporation of orange juice. Essence oil can be fractionated, concentrated or enriched. As used herein, the term “peel oil” refers to the aroma and flavor derived from oranges and other citrus fruit and is largely composed of terpene hydrocarbons, e.g. aliphatic aldehydes and ketones, oxygenated terpenes and sesquiterpenes. From about 0.002% to about 1.0% of aqueous essence and essence oil can be used in citrus flavored juices.

Sweetener Component: The present invention is not affected by the type or concentration of sweeteners. The sweetener may be any sweetener commonly employed for use in beverages. The sweetener can include a monosaccharide or a disaccharide. A certain degree of purity from contamination by metal cations will be expected. Peptides possessing sweet taste are also permitted. The most commonly employed saccharides include sucrose, fructose, dextrose, maltose and lactose and invert sugar. Mixtures of these sugars can be used. Other natural carbohydrates can be used if less or more sweetness is desired. The present invention is also compatible with artificial sweeteners. By way of non-limiting example, artificial sweeteners suitable for use include saccharin, cyclamates, acetosulfam, mogroside, L-aspartyl-L-phenylalanine lower alkyl ester sweeteners (e.g. aspartame), L-aspartyl-D-alanine amides as disclosed in U.S. Pat. No. 4,411,925, L-aspartyl-D-serine amides as disclosed in U.S. Pat. No. 4,399,163, L-aspartyl-L-Ihydroxymethyl alkaneamide sweeteners as disclosed in U.S. Pat. No. 4,338,346, L-aspartyl-1-hydroxy ethylakaneamide sweeteners as disclosed in U.S. Pat. No. 4,423,029, L-aspartyl-D-phenylglycine ester and amide sweeteners as disclosed in European Patent Application 168,112 and the like. A particularly preferred sweetener is aspartame. The amount of the sweetener effective in the beverage mixes of the invention depends upon the particular sweetener used and the sweetness intensity desired.

As described herein, the beverage, comestible, and base-syrup compositions may further include carbohydrates, polyols, amino acids and their corresponding salts, polyamino acids and their corresponding salts, sugar acids and their corresponding salts, nucleotides, organic acids, inorganic acids, organic salts including organic acid salts and organic base salts, inorganic salts, bitter compounds, flavorants and flavoring ingredients, astringent compounds, proteins or protein hydrolysates, surfactants, emulsifiers, flavonoids, alcohols, polymers, other sweet taste improving taste additives imparting such sugar-like characteristics, and combinations thereof.

As used herein, the term “carbohydrate” generally refers to aldehyde or ketone compounds substituted with multiple hydroxyl groups, of the general formula (CH₂O)ₙ, wherein n is 3-30, as well as their oligomers and polymers. The carbohydrates of the present invention can, in addition, be substituted or deoxygenated at one or more positions. Carbohydrates, as used herein, encompass unmodified carbohydrates, carbohydrate derivatives, substituted carbohydrates, and modified carbohydrates. As used herein, the phrases “carbohydrate derivatives”, “substituted carbohydrate”, and “modified carbohydrates” are synonymous. Modified carbohydrate means any carbohydrate wherein at least one atom has been added, removed, substituted, or combinations thereof. Thus, carbohydrate derivatives or substituted carbohydrates include substituted and unsubstituted monosaccharides, disaccharides, oligosaccharides, and polysaccharides. The carbohydrate derivatives or substituted carbohydrates optionally can be deoxygenated at any corresponding C-position, and/or substituted with one or more moieties such as hydrogen, halogen, haloalkyl, carboxyl, acyl, acyloxy, amino, amido, carboxyl derivatives, alkylamino, dialkylamino, arylamino, alkoxy, aryloxy, nitro, cyano, sulfo, mercapto, imino, sulfonyl, sulfenyl, sulfinyl, sulfamoyl, carboalkoxy, carboxamido, phosphonyl, phosphinyl, phosphoryl, phosphino, thioester, thioether, oximino, hydrazino, carbamyl, phospho, phosphonato, or any other viable functional group provided the carbohydrate derivative or substituted carbohydrate functions to improve the sweet taste of the instantly described compositions.

Non-limiting examples of carbohydrates suitable for use in accordance with select embodiments of this invention include, but are not limited to, tagatose, trehalose, galactose, rhamnose, cyclodextrin (e.g., a-cyclodextrin, b-cyclodextrin, and g-cyclodextrin), maltodextrin (including resistant maltodextrins such as Fibersol-2®), dextran, sucrose, glucose, ribulose, fructose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, amylopectin, glucosamine, mannosamine, fucose, glucuronic acid, gluconic acid, glucono-lactone, abequose, galactosamine, beet oligosaccharides, isomalto-oligosaccharides (isomaltose, isomaltotriose, panose and the like), xylo-oligosaccharides (xylotriose, xylobiose and the like), gentio-oligoscaccharides (gentiobiose, gentiotriose, gentiotetraose and the like), sorbose, nigero-oligosaccharides, palatinose oligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose com/starch syrup (e.g., HFCS55, HFCS42, HFCS90), coupling sugars, soybean oligosaccharides, and glucose syrup. Additionally, the carbohydrates as used herein may be in either the D- or L-configuration.

The term “polyol”, as used herein, refers to a molecule that contains more than one hydroxyl group. A polyol may be a diol, triol, or a tetraol which contain 2, 3, and 4 hydroxyl groups, respectively. A polyol also may contain more than four hydroxyl groups, such as a pentaol, hexaol, heptaol, or the like, which contain, 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group.

Non-limiting examples of sweet taste improving polyol additives in embodiments of this invention include erythritol, maltitol, mannitol, sorbitol, lactitol, xylitol, inositol, isomalt, propylene glycol, glycerol (glycerine), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect the taste of the sweetener composition.

Suitable sweet taste improving amino acid additives for use in embodiments of this invention include, but are not limited to, aspartic acid, arginine, glycine, glutamic acid, proline, threonine, theanine, cysteine, cystine, alanine, valine, tyrosine, leucine, isoleucine, asparagine, serine, lysine, histidine, ornithine, methionine, carnitine, aminobutyric acid (alpha-, beta-, or gamma-isomers), glutamine, hydroxyproline, taurine, norvaline, sarcosine, and their salt forms such as sodium or potassium salts or acid salts. The sweet taste improving amino acid additives also may be in the D- or L-configuration and in the mono-, di-, or tri-form of the same or different amino acids. Additionally, the amino acids may be α-, β-, γ-, δ-, and ε-isomers if appropriate. Combinations of the foregoing amino acids and their corresponding salts (e.g., sodium, potassium, calcium, magnesium salts or other alkali or alkaline earth metal salts thereof, or acid salts) also are suitable sweet taste improving additives in embodiments of this invention. The amino acids may be natural or synthetic. The amino acids may also be modified. Modified amino acids refers to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. As used herein, amino acids encompass both modified and unmodified amino acids. As used herein, modified amino acid also may encompass peptides and polypeptides (e.g., dipeptides, tripeptides, tetrapeptides, and pentapeptides) such as glutathione and L-alanyl-L-glutamine.

Head space atmosphere: The presence of either air in the headspace of the beverage product in its container (e.g., a bottle) will have no measurable impact on the composition of the invention. The presence of carbon dioxide gas or other gases that cause the exclusion of oxygen from the beverage (nitrogen, nitrous oxide, etc) may permit the use of reduced concentrations of chemical preservatives employed along with the sequestrants. The concentration of sequestrants required will be dictated only by the type and amount of metal cations that are present in the beverage product.

In accordance with further aspects of the present disclosure, the beverages prepared using the base syrup compositions of the instant invention may also include carbon dioxide regulators, as appropriate, particularly in the case of carbonated beverages. There are a wide variety of compositions that can serve as carbon dioxide regulators. These compositions fall into two categories. The first category is compositions that generate or release carbon dioxide via a controlled chemical reaction. Such compositions include: a) polymers such as aliphatic polyketones which generate carbon dioxide as a degradation by-product of the polymers reaction with oxygen or organic and inorganic carbonates groups that release carbon dioxide upon hydrolysis, especially in the presence of acids. Catalysts, binders, and other additives may be combined with these materials to help control the carbon dioxide release process; and b) organic carbonates such as alkyl carbonates, ethylene carbonate, propylene carbonate, polypropylene carbonate, vinyl carbonate, glycerine carbonate, butylene carbonate, diethyl carbonate, ethyl pyrocarbonate, methylpyrocarbonate, cyclic carbonate acrylates such as trimethylol propane carbonate acrylate, and dialkyl dicarbonates which generate carbon dioxide upon hydrolysis that can be enhanced by reaction with an acid such as citric acid or phosphoric acid.

The second category is sorbent compositions that store carbon dioxide and then release it into the container as carbon dioxide is lost from the package. These include: absorbents such as silica gel; molecular sieves, zeolites, clays, activated alumina, activated carbon, and coordination polymers, metal organic frameworks or “MOF's” and isoreticular metal-organic frameworks or “IRMOF's” which are crystalline materials of metal oxide and organic acids analogous to zeolites. These materials may be engineered to have varying pore sizes and carbon dioxide storage capacity.

The various carbon dioxide generators described above may also be blended into a polymer that makes up the container which contains the beverage. They can also exist as layers in a multilayer closure, liner, or bottle design. Alternatively, they can be molded into an insert or disc that can be placed in the top of the bottle closure or in an insert which could be placed into the finish area of the container.

In systems where moisture is used to regulate the release rate of CO₂, the carbon dioxide regulator can be encapsulated or blended with a suitable polymer selected for its permeability to moisture and CO₂. By proper selection of the encapsulating or barrier polymer, the rate of moisture permeation can be used to control the rate of CO₂ release and match the CO₂ loss rate of the package thereby achieving a package which maintains a near constant internal CO₂ pressure for a period of time. This period of time is referred to as the regulation period.

In systems where oxygen is used to regulate the release rate of CO₂, the carbon dioxide regulator can be encapsulated or blended into a suitable polymer selected for its permeability to oxygen and CO₂. Again, by proper selection, the rate of CO₂ generation can be regulated to match the CO₂ loss rate of the package and maintain a near constant internal CO₂ pressure for a period of time.

When the carbon dioxide regulator is prepared from a CO₂ adsorbing material, the additional CO₂ needed to extend shelf-life may be incorporated through over-carbonation at the point of filling. The package can be over-carbonated with the precise amount of CO₂ needed based upon the desired increase in shelf-life, regulation period, and the CO₂ permeability of the package. The CO₂ regulating material must rapidly absorb this excess CO₂ before the package can deform due to excess CO₂. This absorbance should occur within about six hours and preferably in about one hour. The CO₂ regulator should then release the adsorbed carbon dioxide at a rate less than or preferably approximately equivalent to the rate of carbon dioxide loss from the package itself. This will ensure that a uniform and stable internal CO₂ pressure is maintained. Performance of specific regulator compositions may be optimized by proper drying, impregnating, and fabricating conditions that are well known to those skilled in the art. It is preferred to minimize the volume of the carbon dioxide regulator so that the space of the package is used efficiently.

Alternatively, and equally acceptable, the carbon dioxide regulator may be pre-charged with CO₂ by subjecting it to an environment of CO₂ gas so that it absorbs and holds enough CO₂ gas to replace CO₂ lost from the container during the normal use of the container.

The carbon dioxide regulator may be incorporated into the package in any number of ways. These include, but are not limited to, placing it inside the closure either in a small cup or as a fabricated disk. These designs have several components, the body of the closure, the carbon dioxide regulator material, and a liner or cup material which supports the carbon dioxide regulator and can separates it from the package contents. The liner material can be designed to assist in controlling the CO₂ loss rate of the carbon dioxide regulator material either by acting to control the CO₂ permeation rate directly or by controlling the rate at which an activator can reach the carbon dioxide regulator. Water and water vapor can act as an activator in many systems. The amount of carbon dioxide regulator can vary depending on the requirements of the package. For smaller increases in shelf-life a thin insert may be placed inside the closure. For larger effects, where more carbon dioxide regulator would be required, the cup or plug-closure design would allow large amounts of carbon dioxide regulator to be used.

The carbon dioxide regulator can also be blended into the plastics used to form the body of the package or the closure, e.g., the beverage container. The preform containing the carbon dioxide regulator assembly would then be blown into a bottle using conventional equipment. For such a system, it would be advantageous if the carbon dioxide regulator would not become active until the package was filled with the liquid beverage.

The following examples are included to demonstrate preferred embodiments of the invention. It should be appreciated by those of skill in the art that the techniques disclosed in the examples which follow represent techniques discovered by the inventor(s) to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Example 1

### Preparation and Evaluation of Base Syrups

A study was designed to determine whether a viable liquid base syrup containing a non-nutritive natural sweetener could be made to distribute to melt stations where it would be blended with liquid sucrose or invert, and then distributed to commercial customers.

A first objective of this study was to determine whether a base syrup could be concentrated enough such that only one tote (roughly 250 gallons) or less of base syrup could be sufficiently made to supply one full liquid tanker truck (4,400 gal) of finished blended product. This would be determined by the solubility of the non-nutritive natural sweetener, such as SG95, in invert solutions, and then ultimately the is solubility of the base syrup into liquid sucrose.

Second, a determination needed to be made as to whether an invert/natural sweetener base syrup of low enough color (e.g., having a Harzen color number (APHA) ≦60) such that the final product will not impact the color of the end product application. The commercial Sprite® product by the Coca-Cola Company was used as a comparator for color.

Exemplary base syrups, which consist of a blend of full acid invert (full invert) made from liquid sucrose (obtained from Imperial Sugar, Port Wentworth, Ga.) and SG95 Stevia plant extract powder (SG95 is a natural, high purity combination of nine sweet steviol glycosides found within the stevia leaf, with rebaudioside A (Reb A) accounting for over half of the final composition; available from PureCircle, Oak Brook, Ill.), were prepared by first heating a 68.6 Brix acid invert (full invert) to 80° C., carefully measuring out the appropriate quantity of invert and placing the invert into a Kitchen Aide mixer affixed with a “whisker” attachment. Dry SG95 Stevia powder was then added directly to the hot invert. The mixer was turned on high for approximately 15 seconds to blend the ingredients. After the ingredients were blended, a 33 wt. % solution of sodium benzoate and sodium citrate were added to the mixture. The blender was turned on low speed to blend in the preservatives. Finally, a defoamer was added to the mixture to increase bubble coalescence and decrease bubble suspension. The final mixture was placed on a shelf for 4 days and then refrigerated for at least 2 days to test solution stability, since Stevia plant extracts are known to have a limited solubility in aqueous solutions.

Table 1 provides measured physical properties of exemplary base syrups in accordance with the present disclosure in combination with varying SG95 concentrations.

TABLE 1
Base syrup/sucrose physical properties.

| SG95 | SG95 | Invert | | | Final SG | | | |
|---|---|---|---|---|---|---|---|---|
| (wt %) | (g) | (g) | Weight (g) | Final Brix | conc. | Lb/gal | Appearance | Gal./Truck |
| 10.0% | 15 | 135 | 150 | 71.7% | 1.360 | 11.32 | Turbid | 130.8 |
| 9.1% | 15 | 150 | 165 | 71.5% | 1.359 | 11.31 | Turbid | 144.0 |
| 8.3% | 15 | 165 | 180 | 71.2% | 1.357 | 11.29 | Turbid | 157.3 |
| 7.7% | 15 | 180 | 195 | 71.0% | 1.356 | 11.28 | Turbid | 170.5 |
| 7.1% | 15 | 195 | 210 | 70.8% | 1.355 | 11.27 | Turbid | 183.8 |
| 6.8% | 15 | 205 | 220 | 70.7% | 1.354 | 11.26 | Turbid | 192.8 |
| 6.5% | 15 | 215 | 230 | 70.6% | 1.354 | 11.26 | Turbid | 201.5 |
| 6.3% | 15 | 225 | 240 | 70.6% | 1.353 | 11.25 | Slightly | 210.5 |
| | | | | | | | Turbid | |
| 5.8% | 15 | 245 | 260 | 70.4% | 1.351 | 11.24 | clear | 228.2 |
| 5.3% | 15 | 269 | 225 | 70.3% | 1.349 | 11.23 | clear | 249.6 |

As shown in Table 1, the visual appearance of the syrups, following the stability test, shows that the turbidity of the syrups increased sharply when the concentration of SG95 went above about 6.3 weight %. Based on this initial finding, it is believed that the most beneficial and useful base syrups, having little to no discoloration, will be at or below concentrations of approximately 6.0-7.0 wt. % SG95 in solution and below, such as at about 5.8 wt. % SG95 in solution.

As a full tote bin is approximately 250 gallons, this first finding indicated that the criteria to generate a single tote of base syrup capable of treating a full liquid tanker truck of blended product is viable, as indicated by the last column in Table 1.

### Example 2

### Color Studies of Sucrose/Base Syrup Blends

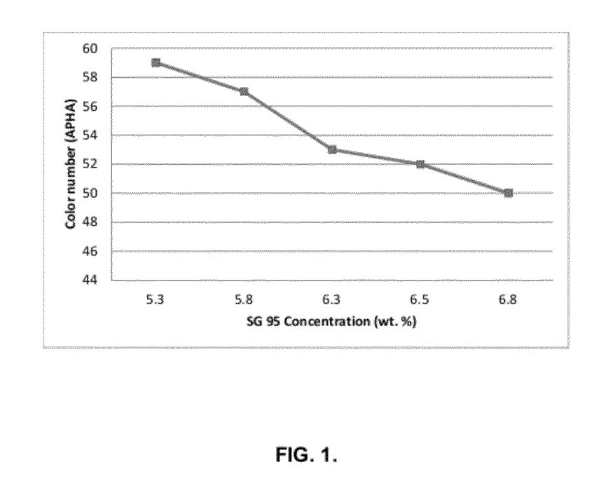

A second set of experiments examined the color of base syrup/sucrose blends for use with beverages and other appropriate comestibles. Exemplary base syrups having SG95 concentrations ranging from about 5.3 wt. % to about 6.8 wt. % and blending the appropriate amount of base syrup in accordance with the present disclosure with liquid sucrose. The samples were prepared by first heating a pre-weighed amount of liquid sucrose (provided by Imperial Sugar, Port Wentworth, Ga.) to approximately 50° C. in a 316 stainless steel pot. Once the sucrose solution reached temperature, a quantity of base syrup that included a Stevia extract in accordance with the present disclosure was added to the sucrose such that the final blended solution would have the same characteristics as a melted stevia-50% sucrose solution. Once combined, the ingredients of the blend were gently stirred together without using high shear agitation. The color of the cucrose/base syrup blends were measured using a colorimetric characterization method, such as ASTM D1209 (“Platinum-Cobalt Color, Test Method D1209”), or DIN EN 1557. The color meter measures color by detecting the amount of light transmitted through a liquid sample at both 420 nm and 720 nm, and the color is expressed as the Harzen color number (APHA); the lower the color number, the more colorless the product is. The results of this study are shown in FIG. 1.

Each of the 5 blends that were studied appeared to be clear. The downward trend in the color with increasing SG95 concentration is consistent with the fact that invert is the main contributor to color, and as more SG95 is available in solution, the less base syrup is required to meet a given sweetness level. Thus, color number trends downward as SG95 concentration increases.

Following this experiment, a 6.5 wt. % SG95 base syrup/Sucrose blend was prepared, and the concentration was reduced to 4 Brix. In comparison to a sample of Sprite®, which typically has about 6 wt. % sugar plus other flavorings and additives, the color of the diluted blend sample was 0.0 compared to the commercial Sprite® product, which had an (APHA) 8.0 color number. The results of the blended products are shown in TABLE 2, below.

TABLE 2
Physical properties of Blended Aquarius Syrups/Liquid Sucrose
and Various Comparators.

| SG95, wt. % In | | Blend Visual | |
|---|---|---|---|
| Base Syrup | Blend Brix | Appearance | Blend Color Number¹ |
| 6.8% | 67.6 | Clear | 59 |
| 6.5% | 67.4 | Clear | 52 |
| 6.3% | 67.8 | Clear | 53 |
| 5.8% | 67.8 | Clear | 57 |
| 5.3% | 68.0 | Clear | 59 |
| Pure (full) Invert | 68.6 | Clear | 257 |
| Liquid Sucrose | 67.2 | Clear | 28 |
| Sprite ® | 10.0 | Clear | 8.0 |
| 6.5% Base | 4.0 | Clear | 0.0 |
| syrup/Sucrose blend | | | |

¹Color number refers to the Harzen color number (APHA), as determined in accordance with ASTM Standard D1209 (05-2011) or DIN EN 1557.

In conclusion, these results show that a stable base syrup composition can be manufactured that is stable, and which can treat an entire tanker load of blended sucrose products. These experiments also illustrate that such base syrup compositions produce a blended product that will have little to no color impact on customer products that require a strict color compliance.

Other and further embodiments utilizing one or more aspects of the inventions described above can be devised without departing from the spirit of Applicant's invention. For example, various combinations of ingredients not specifically set forth herein may be prepared in accordance with the aspects of the present disclosure. Further, the various methods and embodiments of the compositions and preparation methods can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A base syrup composition for use with a beverage, the base syrup comprising:
an invert sugar composition; and
at least one non-nutritive sweetener.

2. The base syrup composition of claim 1, wherein the invert sugar composition is a medium invert.

3. The base syrup composition of claim 1, wherein the non-nutritive sweetener comprises one or more steviosides in an amount of about 0.001 wt. % to about 15 wt. %, based on the finished base syrup weight.

4. The base syrup composition of claim 3, wherein the concentration of non-nutritive sweetener in the base syrup ranges from about 5 wt. % to about 8 wt. %.

5. The base syrup composition of claim 4, wherein the concentration of non-nutritive sweetener in the base syrup ranges from about 5.1 wt. % to about 7 wt. %.

6. The base syrup composition of claim 1, wherein the non-nutritive sweetener comprises rebaudioside A.

7. The base syrup composition of claim 1, wherein the non-nutritive sweetener comprises a Stevia extract.

8. The base syrup composition of claim 1, further comprising a defoaming agent.

9. The base syrup composition of claim 8, wherein the defoaming agent is a silica-containing defoamer or the reaction product of at least one compound with an active hydrogen atom and at least one alkylene oxide, wherein the defoamer has a hydroxyl equivalent molecular weight of at least about 4000 Da.

10. The base syrup composition of claim 8, wherein the concentration of defoaming agent ranges from about 0.001 wt. % to about 0.1 wt. %.

11. A beverage comprising:
about 0.1% by weight to about 98% by weight of a base syrup component, wherein the base syrup component includes an invert sugar and a non-nutritive natural sweetener, and wherein the base syrup has a Harzen color number (APHA) of ≦60;
a pH of 2.5 to 7.5; and
water,
wherein the beverage exhibits a calorie content of from less than about 5 to less than about 90 calories per 8 oz serving of the beverage.

12. The beverage of claim 11, wherein the beverage is a carbonated beverage, a non-carbonated beverage, a soft drink, a fruit juice, a fruit juice flavored drink, a fruit-flavored drink, an energy drink, a hydration drink, a sport drink, a health and wellness drink, a fountain beverage, a frozen ready-to-drink beverage, a frozen carbonated beverage, a liquid concentrate, a coffee beverage, a tea beverage, a dairy beverage, a soy beverage, a vegetable drink, a flavored water, an enhanced water, or an alcoholic beverage.

13. The beverage of claim 11, wherein the beverage component comprises at least one of added water, a juice, a flavorant, a sweetener, an acidulant, a colorant, a vitamin, a buffering agent, a thickener, an emulsifier, and an anti-foaming agent.

14. The beverage of claim 13, wherein the juice is a fruit juice from at least one of orange, grapefruit, lemon, lime, tangerine, apple, grape, cranberry, raspberry, blueberry, strawberry, pineapple, pear, peach, pomegranate, prune, cherry, mango, papaya, lychee, açaí, and guava.

15. The beverage of claim 11, further comprising a non-nutritive sweetener selected from the group consisting of stevioside, an extract from Stevia rebaudiana, a steviaol glycoside, thaumatin, monellin, brazzein, phyllodulcin or a derivative thereof, a Lo Han Guo extract having a mogroside IV or mogroside V content from about 2% to about 99%, inclusive, one or more mogroside extracts from Lo Han Guo, an extract from Momordica species, erythritol, and combinations thereof.

16. The beverage of claim 11, wherein the water is carbonated water.

17. The beverage of claim 11, further comprising a mineral or at least one vitamin.

18. A reduced calorie beverage comprising:
a base syrup comprising a non-nutritive natural sweetener and sugar invert; and
a flavoring,
wherein the base syrup has a Harzen color number (APHA) of ≦60.

19. The reduced calorie beverage of claim 18, further comprising at least one anti-foaming agent.

20. The reduced calorie beverage of claim 18, further comprising a coloring agent.
